(19) United States
(12) Patent Application Publication
(10) Pub. No.: US 2009/0242632 A1
(43) Pub. Date: Oct. 1, 2009

(54) MERCHANDISE IDENTIFICATION INFORMATION INPUT APPARATUS AND MERCHANDISE IDENTIFICATION INFORMATION MISREADING PREVENTION PROGRAM MEDIUM

(75) Inventor: Atsunori Suto, Inagi (JP)

Correspondence Address: GREER, BURNS & CRAIN, 300 S WACKER DR, 25TH FLOOR, CHICAGO, IL, 60606, US

(73) Assignee: FUJITSU FRONTECH LIMITED, Tokyo (JP)

(21) Appl. No.: 12/414,104

(22) Filed: Mar. 30, 2009

(30) Foreign Application Priority Data
Mar. 31, 2008 (JP) 2008-090506

(51) Int. Cl. G06Q 30/00

(52) U.S. Cl. 235/385

(57) ABSTRACT

A barcode scanner that is capable of automatically preventing misreading in scanning the barcodes of the same item for checkout at a cahier register using a stationary-type barcode scanner is provided, by including a merchandise identification information reading unit optically reading merchandise identification information for identifying an item, a merchandise identification information registration unit registering merchandise identification information read in a point-of-sale information management apparatus; and a control unit controlling the merchandise identification information registration unit such that when a number of an item is input by an item number input unit for inputting a number of the item and several pieces of the same merchandise identification information are consecutively read, registration of the consecutively read merchandise identification is not performed for a number of times, the number of times being obtained by subtracting 1 from the number of the item.

### BACKGROUND OF THE INVENTION

1. Field of the Invention

The present invention relates to a barcode scanner (merchandise identification information input apparatus) that reads a barcode (merchandise identification information) to be registered in a POS (point-of-sales information management apparatus), and particularly to a stationary-type barcode scanner that is fixed on a cashier table on which items are placed for checkout.

2. Description of the Related Art

Conventionally, there have been two types of barcode scanners for reading a barcode representing merchandise information; namely, a handheld type that can be held in an operator' s hand and moved close to an item, and a stationary type that is fixed on a cashier table on which items are placed for checkout.

Of the two types, the stationary-type barcode scanner has good operability with which the operator can move an item with one hand or with both hands to read the merchandise information. On the other hand, there has been a problem that, the merchandise information of an item that does not need to be scanned (an item of which merchandise information does not need to be read) and only needs to be moved was also read by the stationary-type barcode scanner, for example, in the case of registering several of the same item in a POS, which requires the barcode to be read only once, in parallel with the input of the number of the item, using number keys and the like.

The following methods have been used for preventing the misreading of the barcodes of several of the same item as describe above.
(1) A method in which an alarm sound that is different from the sound output for the normal reading is output to prompt an error check, when several pieces of the merchandise information of the same item are received consecutively. In this case, if the reading done several times is not by an error, the operation is continued disregarding the alarm sound.
(2) A method in which, before scanning several of the same item, the number of the item is input. Then, only the merchandise information of the first one is read, and the second and subsequent ones are moved away from the scanner, for example, so that no reading operation is performed for them.
(3) A method in which (1) and (2) are combined.

However, in the method of prompting an error check using an alarm sound that is different from the sound made for the normal reading when the several pieces of merchandise information of the same item are received consecutively as in (1) above, the alarm sound and the like may cause uneasy feeling in customers, or an inexperienced operator may miss the alarm sound. Furthermore, there has been a problem in the operability that the operator has to make a decision.

Meanwhile, in the method as (2) above with which, before scanning several of the same item, the number of the item is input and only the merchandise information of the first one is read, while the second and subsequent ones are moved away from the scanner, for example, so that no reading operation is performed for them, the second and subsequent items need to be moved in such a way that they are not scanned. However, the operator may unintentionally scan such items due to the improvement in the reading performance of the barcode scanner, which requires troublesome procedures such as the cancelling operation done by the operator for the registration in the POS.

In addition, when realizing the method with an application, while it is possible to disable the reading with the input of the number, there has been a problem that it is not practical, since the operator is required to perform an operation at the timing for enabling the reading.

### SUMMARY OF THE INVENTION

The present invention has been made for solving the problems described above. An objective of the present invention is to provide a barcode scanner (merchandise identification information input apparatus) that is capable of automatically preventing misreading in scanning the barcodes of the same item for checkout at a cahier register, using a stationary-type barcode scanner

The present invention adopts the following configuration in order to solve the above problems.

According to an aspect of the present invention, a merchandise identification information input apparatus of the present invention include a merchandise identification information reading unit optically reading merchandise identification information for identifying an item, a merchandise identification information registration unit registering merchandise identification information read by the merchandise identification information reading unit in a point-of-sale information management apparatus; an item number input unit for inputting a number of the item; and a control unit controlling the merchandise identification information registration unit such that when a number of an item is input by the item number input unit and several pieces of same merchandise identification information are consecutively read by the merchandise identification information reading unit, registration of the consecutively read merchandise identification is not performed for a number of times, the number of times being obtained by subtracting 1 from the number of the item.

Meanwhile, in the merchandise identification information input apparatus of the present invention, it is desirable that the merchandise identification information reading unit reads the merchandise identification information after a number of an item is input by the item number input unit.

Meanwhile, in the merchandise identification information input apparatus of the present invention, it is desirable that the item number input unit inputs a number of an item after the merchandise information is read by the merchandise identification information reading unit.

Meanwhile, in the merchandise identification information input apparatus of the present invention, it is desirable that after performing a first control of the merchandise identification information registration unit in which registration of the consecutively read merchandise identification is not performed for a number of times, the number of times being obtained by subtracting 1 from the number of the item, the control unit controls the merchandise identification information registration unit to register merchandise identification information that has been read, after the first control, by the merchandise identification information reading unit.

Meanwhile, in the merchandise identification information input apparatus of the present invention, it is desirable that while controlling the merchandise identification information registration unit such that registration of the consecutively read merchandise identification is not performed for a number of times, the number of times being obtained by subtracting 1 from the number of the item, when other merchandise identification information that is different from the same merchandise identification information is read by the merchandise identification information reading unit, the control unit controls the merchandise identification information registration unit to register the read other merchandise identification information.

Meanwhile, in the merchandise identification information input apparatus of the present invention, it is desirable that while controlling the merchandise identification information registration unit such that registration of the consecutively read merchandise identification is not performed for a number of times, the number of times being obtained by subtracting 1 from the number of the item, when a state in which the merchandise identification information reading unit performs the reading of the same merchandise identification information is continued for a predetermined time, the control unit controls the merchandise identification information registration unit to register the same merchandise identification information.

Meanwhile, in the merchandise identification information input apparatus of the present invention, it is desirable that while performing the control of the merchandise identification information registration unit in which registration of the consecutively read merchandise identification is not performed for a number of times, the number of times being obtained by subtracting 1 from the number of the item, when the control unit receives an instruction for cancelling the control, the control unit cancels the control.

Meanwhile, in the merchandise identification information input apparatus of the present invention, it is desirable that when a number of an item is newly input by the item number input unit and another pieces of same merchandise identification information are read consecutively by the merchandise identification reading unit, the control unit controls the merchandise identification information registration unit such that registration of the consecutively read merchandise identification is not performed for a number of times, the number of times being obtained by subtracting 1 from the newly input number of the item.

Meanwhile, in the merchandise identification information input apparatus of the present invention, it is desirable that while controlling the merchandise identification information registration unit such that registration of the consecutively read merchandise identification is not performed for a number of times, the number of times being obtained by subtracting 1 from the number of the item, when a predetermined time has passed, the control unit controls the merchandise identification information registration unit to register the read same merchandise identification information.

Meanwhile, in the merchandise identification information input apparatus of the present invention, it is desirable that while controlling the merchandise identification information registration unit such that registration of the consecutively read merchandise identification is not performed for a number of times, the number of times being obtained by subtracting 1 from the number of the item, the control unit does not output an alarm sound.

Meanwhile, according to an aspect of the present invention, a merchandise identification information misreading prevention program medium makes a computer of a merchandise identification information input apparatus function as a merchandise identification information reading unit optically reading merchandise identification information for identifying an item, a merchandise identification information registration unit registering merchandise identification information read by the merchandise identification information reading unit in a point-of-sale information management apparatus; and a control unit controlling the merchandise identification information registration unit such that when a number of an item is input by an item number input unit for inputting a number of the item and several pieces of the same merchandise identification information are consecutively read by the merchandise identification information reading unit, registration of the consecutively read merchandise identification is not performed for a number of times, the number of times being obtained by subtracting 1 from the number of the item.

### BRIEF DESCRIPTION OF THE DRAWINGS

FIG. 1 is a diagram illustrating the basic configuration of the whole system including a barcode scanner that functions as a merchandise identification information input apparatus according to the present invention;

FIG. 2 is a configuration diagram of a barcode scanner;

FIG. 3 is a configuration diagram of a keyboard;

FIG. 4 is a configuration diagram of a POS;

FIG. 5 is a diagram for explaining the outline of the present invention;

FIG. 6 is a flowchart illustrating the flow of a start process to which the present invention is applied;

FIG. 7 is a flowchart illustrating the flow of a merchandise identification information misreading prevention process to which the present invention is applied; and

FIG. 8 is a flowchart illustrating the flow of a return process to which the present invention is applied.

### DESCRIPTION OF THE EMBODIMENTS

Hereinafter, embodiments adopting the present invention are described.

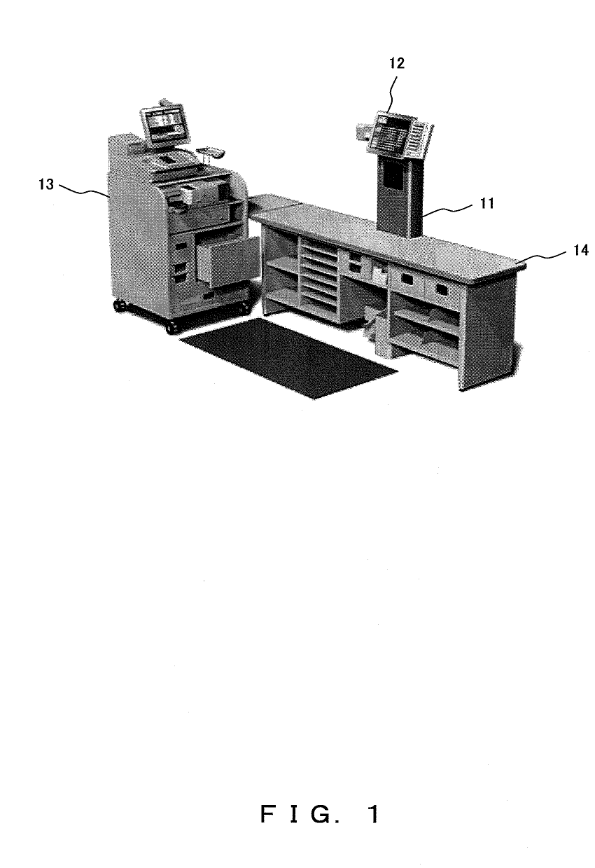

FIG. 1 is a diagram illustrating the basic configuration of the whole system including a barcode scanner that functions as a merchandise identification information input apparatus according to the present invention.

As illustrated in FIG. 1, in a convenience store, a supermarket, an electronics retail store and the like, a barcode scanner 11 is fixed on a cashier table 14 on which merchandise is placed, and scans a barcode attached to an item to be purchased by a customer, to read its information. The barcode scanner 11 then transmits the read barcode information to a POS 13 that performs the checkout process. In addition, the barcode scanner 11 is equipped with a keyboard 12 that has number keys for inputting the number of an item when the customer purchases several of the same item.

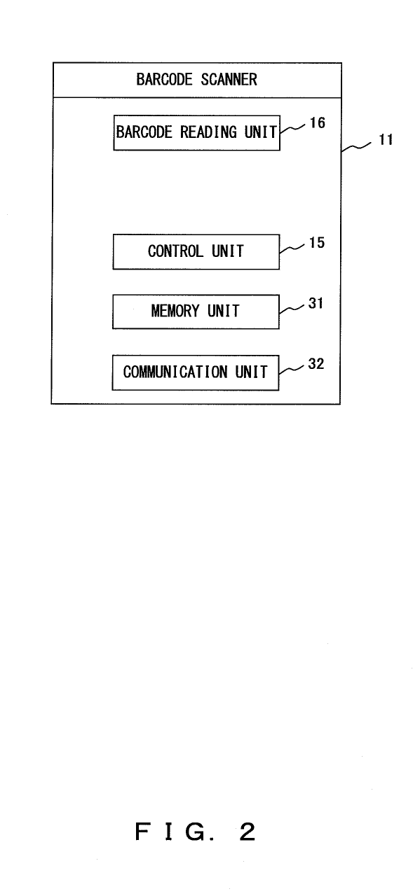

FIG. 2 is a configuration diagram of the barcode scanner.

In FIG. 2, the barcode scanner 11 has a barcode reading unit 16, a control unit 15 that performs controls of, for example, when the barcodes of the same item are read consecutively, the transition from “on” to “off”, or “off” to “on” of the read-and-discard mode, a memory unit 31 that stores information such as the read-and-discard mode on/off information of a barcode, and a communication unit 32 for communicating with the POS 13.

The barcode scanner 11 reads a barcode attached to an item as sales information of the item, in accordance with the movement of the item placed on the cashier table 14, for example, from right to left in front of the barcode scanner 11, the movement being made by the operator. The barcode scanner 11 then transmits the information of the read barcode to the POS 13.

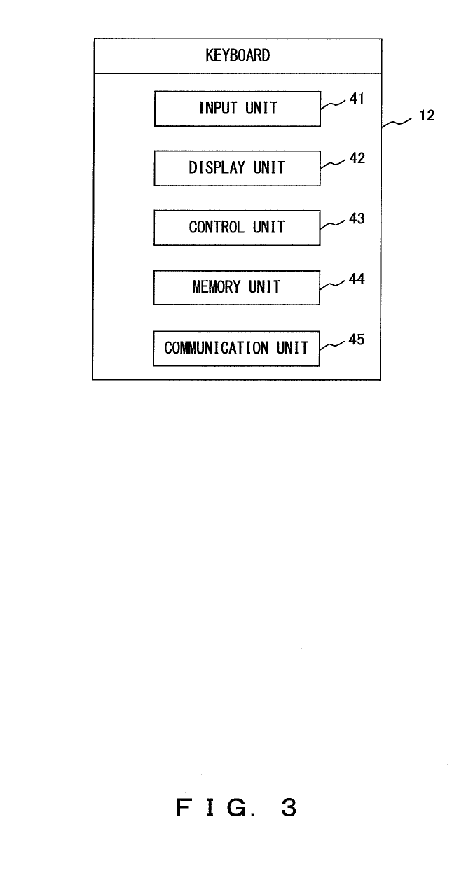

FIG. 3 is a configuration diagram of the keyboard.

In FIG. 3, the keyboard 12 has an input unit 41 for inputting the number of an item and the like, a display unit 42 that displays the input number and the like, a control unit 43 that controls the keyboard 12 as a whole, a memory unit 44 that stores information such as the merchandise information of an item to be purchased by a customer, and a communication unit 45 for communicating with the POS 13. The display unit 42 may be used as a customer display that displays, with respect to an item purchased by a customer, for example, the price in the barcode information read by the barcode scanner 11, the display being made every time the barcode scanner 11 scans a barcode. In that case, the customer can see the display on the display unit 42 to check the prices of the items that the customer purchases.

When a number key, an enter key, a clear key and the like are tapped on the keyboard 12, the information of the tapped key is transmitted to the POS 13 via the communication unit 45.

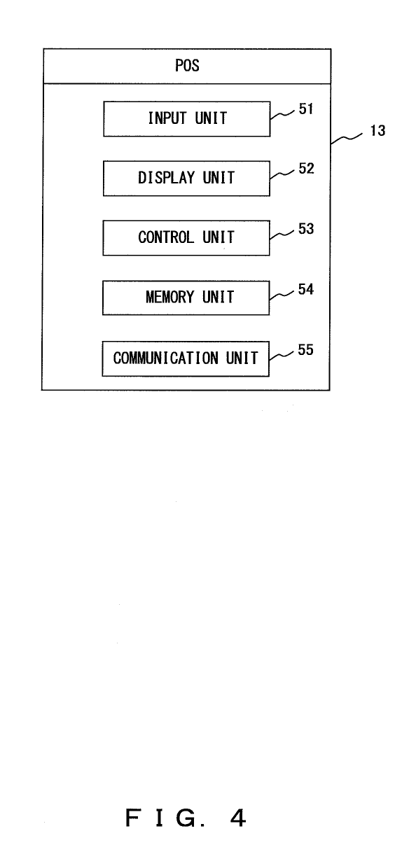

FIG. 4 is a configuration diagram of the POS.

In FIG. 4, the POS 13 has an input unit 51 for inputting information such as the information of the price of an item and the amount of money received from the customer as the payment for items, a display unit 52 for displaying information such as the price of each item, the subtotal amount of the prices and the like, a control unit 53 that controls the POS 13 as a whole, a memory unit 54 that stores the total amount of the prices of purchased items, and a communication unit 55 for communicating with the barcode scanner 11, the keyboard 12 and the like.

The POS 13 collects sales information and the like of each item for the checkout of the items being sold, using the barcode scanner 11 and the keyboard 12 as input devices.

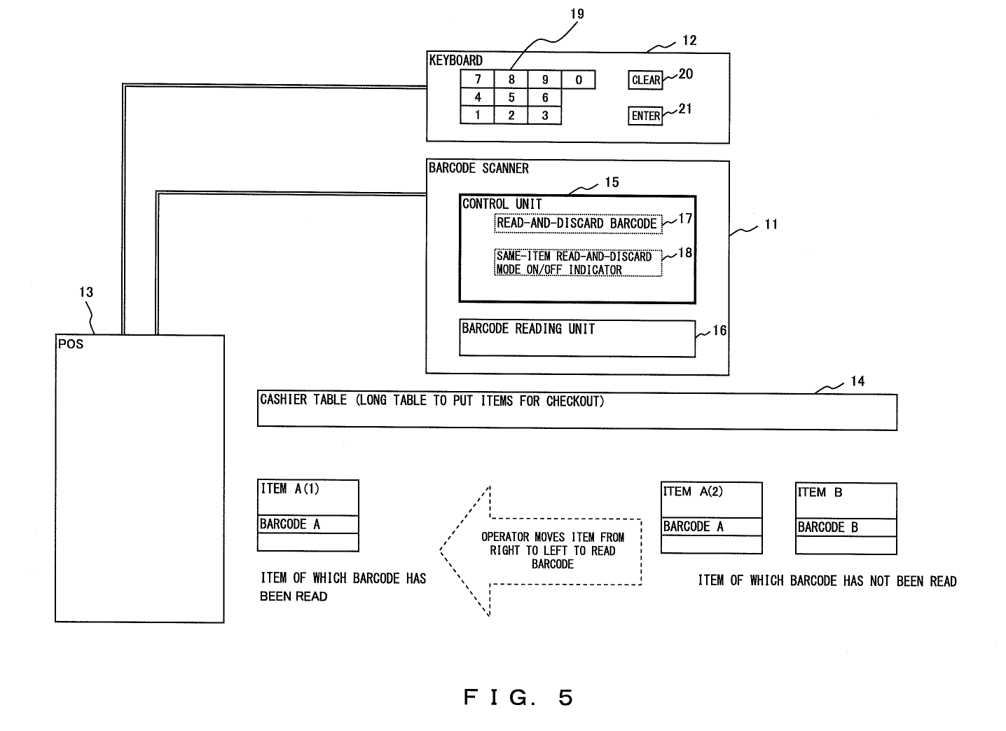

FIG. 5 is a diagram for explaining the outline of the present invention.

A feature of the present invention is that, before reading barcodes attached to the same item, i.e., barcodes having the same contents, the number of the same items is input and the number data is registered, at the time of the input, in the memory unit 31 of the stationary-type barcode scanner 11, so as to perform the control with which the reading operation of the barcodes of the item registered in the memory 31 by the stationary-type barcode scanner 11 is disabled until a barcode of another type of item is input. There are various conditions for returning to the normal state from the disabled state, which are to be described later.

Next, the flow of the implementation of the present invention is described. Here, a case in which a customer buys two pieces of item A and one piece of item B is described as an example.

An operator first confirms that there are two pieces of item A (item A(1) and item A(2)). Then, the operator inputs the number using the number key 19 of the keyboard 12. In other words, the operator taps the number key “2”.

Next, the operator picks up one of the two pieces of item A (item A(1)); scans the barcode by passing it in front of the barcode scanner 11; and registers the item. The operator then moves the one of item A (item A(1)) to a registered item storage basket.

The operator then moves another of the two pieces of item A (item A(2)) to the registered item storage basket without scanning it.

Next, the operator picks up item B that is different from item A, and scans the barcode in the same manner as for item A. The operator then moves item B to the registered item storage basket.

In the series of processes described above, the following control is performed according to the present invention.
(1) The number of the item input using the number key 19 of the keyboard 12 is transmitted to the POS 13 via the communication unit 45. The POS 13 instructs the stationary-type barcode scanner 11 to shift to the same-item reading mode.
(2) The barcode scanner 11 that has received the instruction for the same-item reading mode from the POS 13 shifts to the same-item reading mode.
(3) The barcode scanner 11 stores, in the memory unit 31, a barcode that is read first after shifting to the reading mode.
(4) When a barcode that is read next is the same barcode, the barcode scanner 11 disregards the reading, without providing any alarm sound.
(5) In addition, when any of conditions (a) thorough (c) below is satisfied, return from the same-item reading mode to the normal reading mode is performed.
   (a) When a barcode that does not correspond to the barcode that was read first after the shift to the reading mode is received.
   (b) When the maximum number of items specified in advance have been scanned.
   (c) When the same barcode is read for several times consecutively in terms of the scanning timing. In other words, when the actual number of the item exceeds the registered number (for example, the registered number is three while there are four of the item actually).

In the case as described above, conventionally, for example, when the three of the item have been put into the registered item storage basket and another one of the same item being the fourth one is scanned, an alarm sound is provided indicating that the same item has been scanned consecutively. Then, the operation is continued while disregarding the alarm sound, or the process is continued after tapping a confirmation button and the like.

However, when the present invention is applied, the reading sound (alarm sound) is not provided even when the three of the item have been put into the registered item storage basket and another one of the same item being the fourth one is scanned, so the item is kept in front of the barcode scanner 11 for a predetermined time. Then, the mode returns to the normal mode, and the process can be continued with the normal reading sound.

Meanwhile, the barcode scanner 11 has a known function for, when the same barcode is continuously read for longer than a predetermined time when reading barcodes, recognizing it as a chattering of the reading operation, and transmitting it as one barcode. The present invention uses the function, and when the same barcode is placed in front of the barcode scanner 11 for longer than a predetermined time, it is determined as overtime reading.

Next, a merchandise identification information input process adopting the present invention is described.

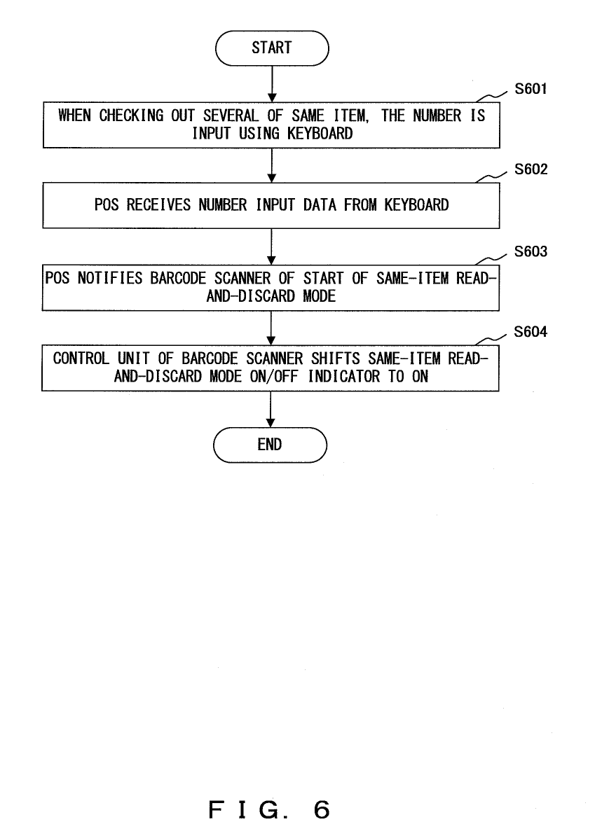

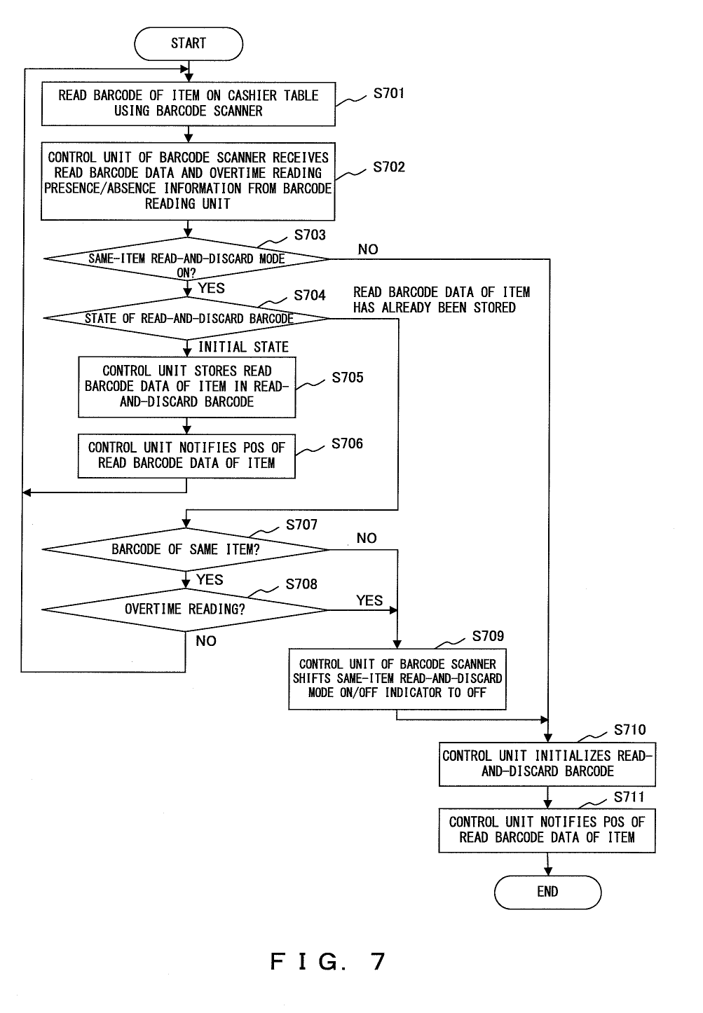

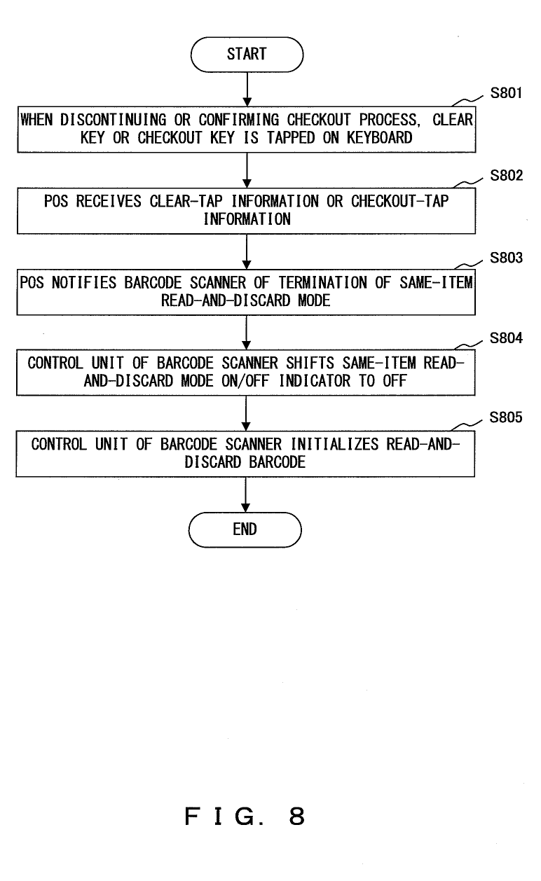

A merchandise identification input process adopting the present invention includes a start process in which startup is a performed with the input of the number of the same item, a merchandise identification information misreading prevention process in which a barcode is read and the mode enters the same-item read-and-discard mode, and a return process for returning to the normal mode. The flow of these processes is explained using the flowcharts in FIG. 6, FIG. 7 and FIG. 8.

FIG. 6 is a flowchart illustrating the flow of a start process to which the present invention is applied.

First, in step S601, in the case of checking out several of the same item, the number of the same item is input by tapping the number key 19 of the keyboard 12.

Then, in step S602, the POS 13 receives the number that has been input using the keyboard 12 as input data, and in step S603, the POS 13 notifies the barcode scanner 11 of the start of the same-item read-and-discard mode.

Then, in step S604, the control unit 15 of the barcode scanner 11 shifts a same-item read-and-discard mode on/off indicator 18 to “yes”.

FIG. 7 is a flowchart illustrating the flow of a merchandise identification information misreading prevention method to which the present invention is applied.

First, in step S701, the barcode scanner 11 reads the barcode of an item placed on the cashier table 14.

Then, in step S702, the control unit 15 of the barcode scanner 11 receives the barcode data of the item read using the barcode reading unit 16 and information indicating the presence/absence of overtime reading. When the barcode of an item is placed for reading continuously for longer than a predetermined time, the barcode reading unit 16 notifies the control unit 15 of information indicating the presence of overtime reading, along with the barcode data. The determination of the presence/absence of overtime reading is performed in the barcode reading unit 16 using a known art such as the one described above.

Next, whether the same-item read-and-discard mode on/off indicator 18 is “yes” or not (whether it is “no) is determined in step S703.

When the same-item read-and-discard mode on/off indicator 18 is determined as not being “yes”, in other words, when same-item read-and-discard mode on/off indicator 18 is determined as being “no”, (step S703: NO) the process proceeds to step S710 described later.

On the other hand, when the same-item read-and-discard mode on/off indicator 18 is determined as “on” (step S703: YES), whether or not a read-and-discard barcode 17 has already stored the barcode data of the read item, or the read-and-discard barcode 17 is in the initial state is determined in step S704.

When it is determined as in the initial state, the control unit 15 stores the read barcode data of the item in the read-and-discard barcode 17, in step S705. In step S706, the control unit 15 notifies the POS 13 of the read barcode data of the item.

On the other hand, when the barcode data is determined as already stored in step S704, whether or not it is the barcode of the same item is determined in step S707.

When it is determined as the barcode of the same item (step S707: YES), the presence/absence of overtime reading is determined further in step S708.

When it is not determined as the barcode of the same item (step S707: NO), or overtime reading has occurred (step S708: YES), the control unit 15 of the barcode scanner 11 shifts the same-item read-and-discard mode on/off indicator 18 to “off”.

Then, in step S710, the control unit 15 initializes the read-and-discard barcode 17, and in step S711, the control unit 15 notifies the POS 13 of the read barcode data of the item.

Meanwhile, in step S710, the process in which the control unit 15 initializes the read-and-discard barcode 17 can be replaced with a process in which the control unit 15 stores the read barcode data of the item in the read-and-discard barcode 17, to enable the process order according which the number of the same item is input after the barcode is scanned.

FIG. 8 is a flowchart illustrating the flow of a return process to which the present invention is applied.

First, in step S801, in the case of discontinuing or confirming the checkout process, when the clear key 20 or a checkout key of the keyboard 12 is tapped, the POS 13 receives, in step S802, from the keyboard 12, clear-tap information that indicates that the clear key 20 has been tapped, or checkout-tap information that indicates that the checkout key has been tapped.

Then, in step S803, the POS 13 notifies the barcode scanner 11 of the termination of the same-item read-and-discard operation.

Next, instep 804, the control unit 15 of the barcode scanner 11 shifts the same-item read-and-discard mode on/off indicator 18 to “off”. In step S805, the control unit 15 of the barcode scanner 11 initializes the read-and-discard barcode 17.

While embodiments of the present invention has been described referring to the drawings, the merchandise identification information input apparatus adopting the present invention is not limited to the embodiments described above as long as its functions are realized, and may be either a single apparatus; a system or an integrated apparatus composed of a plurality of apparatuses, or a system in which the processes are performed through a network such as LAN, WAN, and the like.

In addition, the present invention may be realized with a system composed of a CPU, a memory such as ROM and RAM, an input apparatus, an output apparatus, an external storage apparatus, a medium driving apparatus, a portable storage medium, and a network connection apparatus that are connected to a bus. In other words, the present invention may be realized by providing the merchandise identification information input apparatus with a memory such as ROM and RAM, an external storage apparatus or a portable storage medium storing the program codes of software that realizes the embodiments described above, making the computer of the merchandise identification information input apparatus read out and execute the program codes.

In this case, the program codes themselves read from the portable storage medium or the like realizes the new function of the present invention and the portable storage medium and the like storing the program codes also constitutes the present invention.

For the portable storage medium for providing the program codes, a flexible disk, a hard disk, an optical disk, a magneto-optical disk, CD-ROM, CD-R, DVD-ROM, DVD-RAM, a magnetic tape, a non-volatile memory card, a ROM card, various storage media storing the program codes via the network connection device (in other words, communication line), such as electronic mail, personal computer communications or the like can be used.

The function of the above-described embodiments can be realized by executing the program codes read on the memory by a computer. Besides, the function of the above-described embodiments can be also realized by enabling OS or the like run on a computer to perform a part or all of the actual processes according to the instructions of the program codes.

Furthermore, the function of the above-described embodiments can be realized by enabling a CPU provided for a function extension board inserted into a computer or a function extension unit connected to a computer to perform a part or all of the actual processes according to the instructions of program codes after program codes read from the portable storage medium or programs (data) provided by a program (data) provider are written into the function extension board or the function extension unit.

To summarize, the present invention is not limited to the above-described embodiments and can take various configurations or shapes as long as the subject matter of the present invention is not deviated.

According to the present invention, when registering the same item in a POS, the misreading of barcode information due to the movement of the item after its number is input can be prevented.

In addition, according to the present invention, no alarm sound and the like indicating a warning is emitted from the barcode scanner, causing no uneasy feeling in customers.

In addition, according to the present invention, an operator can continue the reading operation of the barcode of a next item, without being aware of the barcode scanner being in the state in which the reading operation is disabled.

What is claimed is:

1. A merchandise identification information input apparatus comprising:
a merchandise identification information reading unit optically reading merchandise identification information for identifying an item,
a merchandise identification information registration unit registering merchandise identification information read by the merchandise identification information reading unit in a point-of-sale information management apparatus;
an item number input unit for inputting a number of the item; and
a control unit controlling the merchandise identification information registration unit such that when a number of an item is input by the item number input unit and several pieces of same merchandise identification information are consecutively read by the merchandise identification information reading unit, registration of the consecutively read merchandise identification is not performed for a number of times, the number of times being obtained by subtracting 1 from the number of the item.

2. The merchandise identification information input apparatus according to claim 1, wherein
the merchandise identification information reading unit reads the merchandise identification information after a number of an item is input by the item number input unit.

3. The merchandise identification information input apparatus according to claim 1, wherein
the item number input unit inputs a number of an item after the merchandise information is read by the merchandise identification information reading unit.

4. The merchandise identification information input apparatus according to claim 1, wherein
after performing a first control of the merchandise identification information registration unit in which registration of the consecutively read merchandise identification is not performed for a number of times, the number of times being obtained by subtracting 1 from the number of the item, the control unit controls the merchandise identification information registration unit to register merchandise identification information that has been read, after the first control, by the merchandise identification information reading unit.

5. The merchandise identification information input apparatus according to claim 1, wherein
while controlling the merchandise identification information registration unit such that registration of the consecutively read merchandise identification is not performed for a number of times, the number of times being obtained by subtracting 1 from the number of the item, when other merchandise identification information that is different from the same merchandise identification information is read by the merchandise identification information reading unit, the control unit controls the merchandise identification information registration unit to register the read other merchandise identification information.

6. The merchandise identification information input apparatus according to claim 1, wherein
while controlling the merchandise identification information registration unit such that registration of the consecutively read merchandise identification is not performed for a number of times, the number of times being obtained by subtracting 1 from the number of the item, when a state in which the merchandise identification information reading unit performs the reading of the same merchandise identification information is continued for a predetermined time, the control unit controls the merchandise identification information registration unit to register the same merchandise identification information.

7. The merchandise identification information input apparatus according to claim 1, wherein
while performing the control of the merchandise identification information registration unit in which registration of the consecutively read merchandise identification is not performed for a number of times, the number of times being obtained by subtracting 1 from the number of the item, when the control unit receives an instruction for cancelling the control, the control unit cancels the control.

8. The merchandise identification information input apparatus according to claim 1, wherein
when a number of an item is newly input by the item number input unit and another pieces of same merchandise identification information are read consecutively by the merchandise identification reading unit, the control unit controls the merchandise identification information registration unit such that registration of the consecutively read merchandise identification is not performed for a number of times, the number of times being obtained by subtracting 1 from the newly input number of the item.

9. The merchandise identification information input apparatus according to claim 1, wherein
while controlling the merchandise identification information registration unit such that registration of the consecutively read merchandise identification is not performed for a number of times, the number of times being obtained by subtracting 1 from the number of the item, when a predetermined time has passed, the control unit controls the merchandise identification information registration unit to register the read same merchandise identification information.

10. The merchandise identification information input apparatus according to claim 1, wherein
while controlling the merchandise identification information registration unit such that registration of the consecutively read merchandise identification is not performed for a number of times, the number of times being obtained by subtracting 1 from the number of the item, the control unit does not output an alarm sound.

11. A merchandise identification information input apparatus comprising:
merchandise identification information reading means optically reading merchandise identification information for identifying an item,
merchandise identification information registration means registering merchandise identification information read by the merchandise identification information reading means in a point-of-sale information management apparatus;
item number input means inputting a number of the item; and
a control means controlling the merchandise identification information registration means such that when a number of an item is input by the item number input means and several pieces of same merchandise identification information are consecutively read by the merchandise identification information reading means, registration of the consecutively read merchandise identification is not performed for a number of times, the number of times being obtained by subtracting 1 from the number of the item.

12. A merchandise identification information misreading prevention program medium making a computer of a merchandise identification information input apparatus function as:
a merchandise identification information reading unit optically reading merchandise identification information for identifying an item,
a merchandise identification information registration unit registering merchandise identification information read by the merchandise identification information reading unit in a point-of-sale information management apparatus; and
a control unit controlling the merchandise identification information registration unit such that when a number of an item is input by an item number input unit for inputting a number of the item and several pieces of the same merchandise identification information are consecutively read by the merchandise identification information reading unit, registration of the consecutively read merchandise identification is not performed for a number of times, the number of times being obtained by subtracting 1 from the number of the item.
